(19) United States
(12) Patent Application Publication
(10) Pub. No.: US 2017/0150189 A1
(43) Pub. Date: May 25, 2017

(54) METHOD FOR ENCAPSULATING AUDIOVISUAL CONTENT STREAMS IN MPEG2 PRIVATE SECTIONS, DEVICE FOR ENCAPSULATING AUDIOVISUAL CONTENT IN MPEG2 PRIVATE SECTIONS TO BE MULTIPLEXED IN A MPEG2 TRANSPORT STREAM; INTERACTIVE APPLICATION FOR DIGITAL TV; USER DEVICE; METHOD FOR TRANSMISSION OF AUDIOVISUAL CONTENT AND/OR DATA AND COMMUNICATION PROTOCOL FOR DATA NETWORKS

(71) Applicant: TQTVD SOFTWARE LTDA, Rio de Janeiro, RJ (BR)

(72) Inventors: David Estevam DE BRITTO, Niteroi, RJ (BR); Flavio Augusto COUTINHO CORREIA, Rio de Janeiro, RJ (BR); Hernan Rafael PERRONE, Rio de Janeiro, RJ (BR); Luiz David Sales DE PAULA CAMPELO, Rio de Janeiro, RJ (BR); Roberto RIEIRO ALVES, Rio de Janeiro, RJ (BR)

(21) Appl. No.: 15/309,760

(22) PCT Filed: May 8, 2015
(86) PCT No.: PCT/BR2015/050055

§ 371 Date: Nov. 8, 2016

(30) Foreign Application Priority Data
May 9, 2014 (BR) BR1020140112634

(51) Int. Cl. H04N 21/236; H04N 21/4363; H04N 21/235

(52) U.S. Cl. CPC H04N 21/236; H04N 21/235; H04N 21/4363

(57) ABSTRACT

The present invention relates to a method for the transmission of audiovisual content and/or data to user devices without using digital television tuning resources, in that said content is encapsulated in MPEG2 private sections, subsequently multiplexed and transmitted over a digital television signal. The method uses an interactive application transmitted in a digital television signal which, when executed in the digital television receiver, extracts the MPEG2 private sections containing the audiovisual content and/or data from the digital television signal and, using a local area network (LAN) connection, forwards this audiovisual content and/or data to other user devices connected to the same local area network (LAN) as the digital television receiver. Also described is a device for the transmission of audiovisual content and/or data encapsulated in the MPEG2 private section.

### FIELD OF THE INVENTION

The present invention refers to a method, a device and an interactive application in the field of digital TV broadcasting and user devices without tuning resources of digital TV. In particular, the present invention refers to a method, a device and an interactive application in the field of digital TV broadcasting which allows the transmission of content and/or data to user devices that do not have resources for tuning digital TV signals, through a broadcast digital TV signal, using the data-broadcasting technology already available.

### HISTORY OF THE INVENTION

The patent application WO2013/104044 describes a technique for synchronization of contents in a digital TV signal, received by a digital TV receiver, with multiple portable user devices with or without internet access. Furthermore, this document describes a transmission method of an interactive application in the broadcast digital TV signal, using a DSMCC Data (or Object) Carousel, as described by ISO13818-6. This interactive application is decoded and executed by the digital TV receiver within a data-broadcasting execution environment, also known as digital TV middleware, and uses an API available in such execution environment to find other devices connected to the same local area network (LAN) where the digital TV receiver is connected, and to forward to them the contents which are being transmitted along with the interactive application in the DSMCC Data (or Object) Carousel. It is also described the capacity of this method to synchronize the contents shown in user devices with the content sent by the broadcaster. The user devices may be, in many cases, second-screen devices, also known as companion devices, such as tablets or smart-phones running a second-screen application.

A disadvantage of this technique is that the total size of content that can be delivered to the user devices is restricted to the size of what can be transmitted in the DSMCC Data Carousel. Also, the response time of the contents available and the synchronization of contents are limited due to the time required by digital TV receiver to complete the download of a DSMCC Data Carousel update, which, usually, is higher than 10 seconds. These restrictions make unfeasible the delivery of a very large audiovisual content, as for example, a video file with more than 10 seconds, or even live content, as for example, a live video stream.

The ISO13818-1 Standard defines the MPEG2 system and, in particular, the MPEG2-private-sections. MPEG2-private-sections are data structures which can be included in a MPEG2-transport-stream for digital TV. A set of these structures, known as PSI, is normally used to the inclusion of metadata describing the MPEG2-transport-stream, listing and identifying the services and their components, such as the elementary streams—audio, video, subtitles, closed-captions, DSMCC carousels and stream events, interactive application signaling, etc., or the channel programming information that feed the Electronic-Program-Guide (EPG). These structures have, as an identifier, a packet_id (PID) and a table_id (TID). Some values of PID and TID are reserved for specific functions in the digital TV system, but some other non-reserved identifiers can be used for transmission of any other type of information. FIG. 3 details the structure of a MPEG2-private-section. The maximum size of a MPEG2-private-section structure is limited up to 4095 bytes.

It is also known by the skilled in the art the fact that several interactive systems of digital TV include an API or mechanism to allow the interactive applications to extract the MPEG2-private-section structures from MPEG2-transport-stream received by digital TV receiver. As an example, it can be mentioned the API org.davic.mpeg.sections present in the systems based on Globally Executable MHP (GEM) or the API com.sun.dtv.filtering defined in the Brazilian norm ABNT NBR 15606-6.

In recent years, with the increasing number of portable devices such as tablets and smart-phones, the concept of second-screen devices or second-screen applications has been increasing in the entertainment area and, especially, in the TV area. Generally, a second-screen solution allows users to access audiovisual content and/or data complementary to the main content displayed in the TV receiver, that is, the first screen. Many of these solutions depend on that internet access is available for the second-screen devices to retrieve and display complementary content. The disadvantage of this type of solution is that it may require high costs of investment and maintenance, on the broadcaster's side, to ensure a server infrastructure and band width able to support massive and simultaneous access, for example, more than 12 millions of simultaneous accesses. On the other hand, it is much more economically efficient to provide these complementary contents in the same digital TV signal broadcast in which is transmitted the main TV content. FIG. 1, which will be described below, provides an overview of this method to delivery to the user device complementary content through Internet.

### BRIEF DESCRIPTION OF THE INVENTION

The present invention refers to a method, an MPEG2-private-section encapsulator device, an interactive application, a communication protocol for data networks and other mechanisms to deliver the audiovisual content and/or data that are transmitted in a digital TV signal broadcast to user devices which do not have capacity to receive a digital TV signal broadcast.

In some implementations, the method to deliver the audiovisual content and/or data to user devices which do not have capacity to receive digital TV signal broadcast, according to the present invention, includes a device for adaptation (or transcoding) of the audiovisual content to a format that can be reproduced in user devices. These adaptations can include, for example, adjust the video's resolution and aspect ratio, audio and video bitrate and audio and video encodings.

In some implementations according to the present invention, the method includes a MPEG2-private-section encapsulator device to encapsulate the adapted audiovisual content and/or data in MPEG2-private-sections, and serialize in a MPEG2-transport-stream-packets stream for posterior multiplexing in a MPEG2-transport-stream to be transmitted in a digital TV signal broadcast.

In some implementations according to the present invention, in the same MPEG2-transport-stream to be transmitted in a digital TV signal broadcast, an interactive application intended to be executed by the digital TV receiver is multiplexed and transmitted. As can be expected, this MPEG2-transport-stream also contains the main TV content, that is, audio, video, closed captions/subtitles, etc.

In some implementations according to the present invention, the digital TV receiver can be a TV set or a set-top-box. When the digital TV receiver tunes into a digital TV signal broadcast, it decodes the MPEG2-transport-stream and reproduces the main TV content, which is, audio, video, closed captions/subtitles, etc., in the screen and loudspeakers of the digital TV receiver. Alternatively, in the case of set-top-boxes, the contents are output through the respective audio and video outputs. Additionally, the digital TV receiver decodes and executes the interactive application within its execution environment, or interactive digital TV middleware, as MHP, Ginga, etc. The interactive application uses the API available in the execution environment to extract the MPEG2-private-sections that encapsulate the audiovisual content and/or data from the MPEG2-transport-stream. As examples of theses API, it can be mentioned the API org.davic.mpeg.sections of the systems based on the Globally Executable MHP (GEM) specification and com.sun.dtv.filtering API specified by the Brazilian norm ABNT NBR 15606-6.

In some implementations according to the present invention, the digital TV receiver is connected to a local area network (LAN). This LAN can be wired (Ethernet), wireless (such as IEEE 802.11a/b/g/n or similar) or a combination of both types, wired and wireless.

In some implementations according to the present invention, it is required to be implemented by interactive application and the user devices a communication protocol for data networks, based on IP networks, for communication between them when connected to the same LAN.

In some implementations according to the present invention, the communication protocol for data networks provides a discovery mechanism to allow the interactive application and the user devices to become aware of the presence of each other in the same LAN.

In some implementations according to the present invention, the discovery mechanism may require that the interactive application announces its presence to the user devices, that the user devices announces their respective presences to the interactive application, or any combination of both cases.

In some implementations according to the present invention, the communication protocol for data networks provides an announcement of audiovisual content mechanism and a data announcement mechanism which allows the user devices to become aware of the contents that are available through the interactive application. In some implementations of these mechanisms, it may be required that the interactive application announces the availability of such contents, that the user devices query the interactive application about the contents that are available in a given time or any combination of these cases.

In some implementations according to the present invention, the communication protocol for data networks provides an audiovisual content request mechanism and a data request mechanism allowing the user devices to request to the interactive application to deliver the audiovisual content and/or data extracted from MPEG2-transport-stream.

In some implementations according to the present invention, the communication protocol for data networks can provide a audiovisual content delivery mechanism and a data delivery mechanism allowing the interactive application to deliver the audiovisual content and/or data extracted from MPEG2-transport-stream to the user devices.

In some implementations according to the present invention, the user devices should be able to receive the audiovisual content and/or data delivered by interactive application and to make the decoding processes, processing and interpretation in order to render and/or exhibit the audiovisual content and/or data in their respective screens and loudspeakers.

In some implementations according to the present invention, the user devices may be tablets, smart-phones, personal computers and any other device able to connect to a LAN and that has a screen, an audio output such as loudspeakers or headphones, or any combination of these elements.

In some implementations according to the present invention, the user devices may execute one or more applications to support the behaviors, functionalities and the protocols described herein.

### BRIEF DESCRIPTION OF THE FIGURES

FIG. 1 is a block diagram providing an overview of the already existing methods to deliver the complementary content to the user device using the Internet.

FIG. 2 is a block diagram providing an overview of the method to deliver the audiovisual content and/or data to user devices without capabilities of tuning a digital TV signal broadcast.

FIG. 3 is a block diagram depicting the transmission process for delivering the audiovisual content and/or data to the user devices without capabilities of tuning a digital TV signal broadcast.

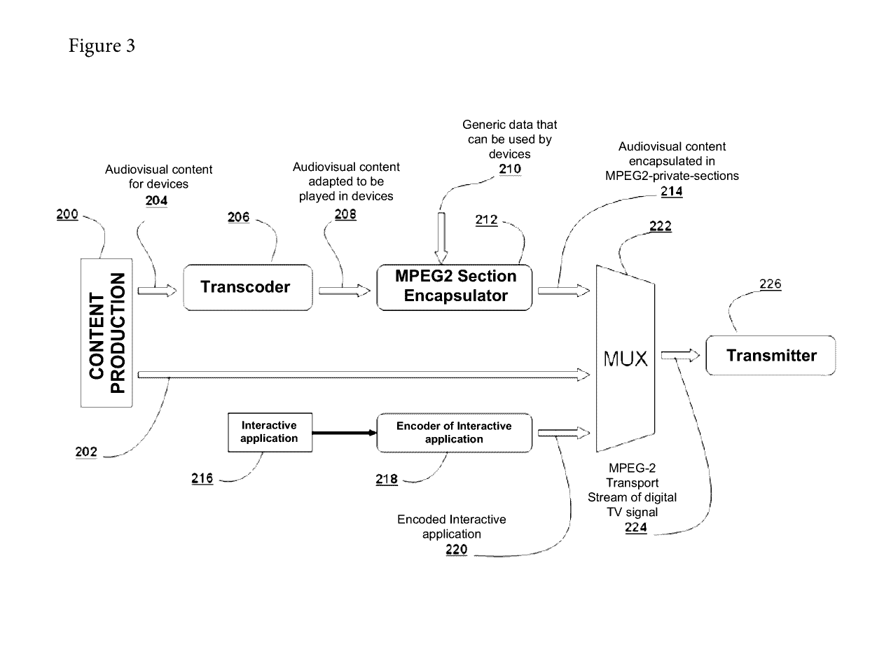

FIG. 4 describes the logical structure of a MPEG2-private-section.

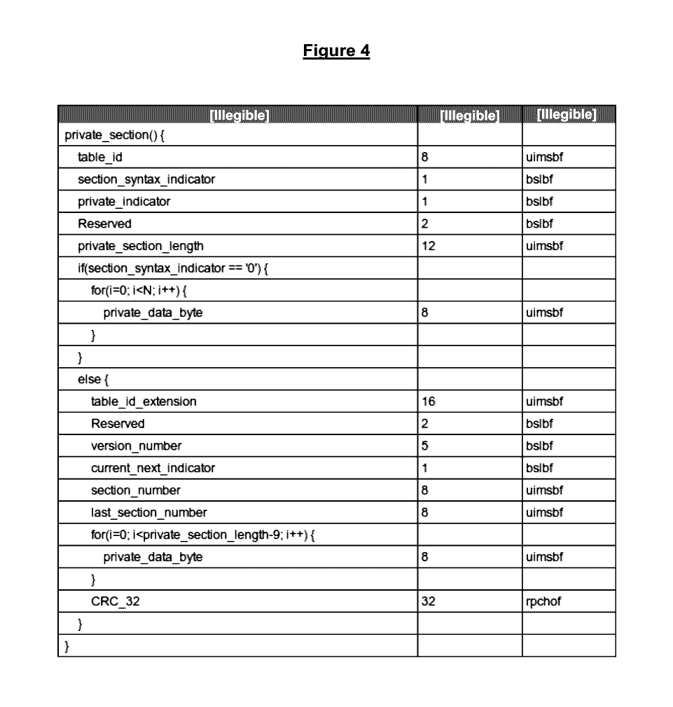

FIG. 5 describes a network communication protocol which allows for communication between interactive application and user devices.

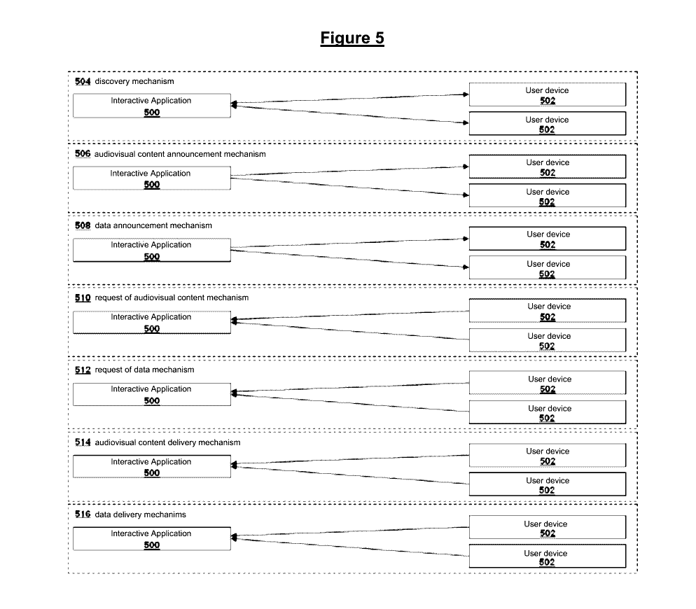

FIGS. 6a-6c describe block diagrams providing an overview of audiovisual content announcement and data announcement.

### DETAILED DESCRIPTION OF THE INVENTION

### Technical Problem

The object of the present invention is to provide means to deliver audiovisual content and/or data which are transmitted in a digital TV signal broadcast to user devices which do not have capabilities to receive a digital TV signal broadcast. Examples of user devices may be tablets or smart-phones used as second-screen devices to access to contents complementary to main TV content rendered in the digital TV receiver, which is also known as main screen or main device. Such complementary content may be audiovisual content, as for example, video clips and/or audio, live video broadcasts, or data, as for example, texts, photos, statistics, etc. Normally, the complementary content may be related to the main TV content, but this is not a necessary condition.

Due to the lack of capabilities to receive digital TV signal broadcast in such user devices, generally, the complementary content is received through an Internet connection.

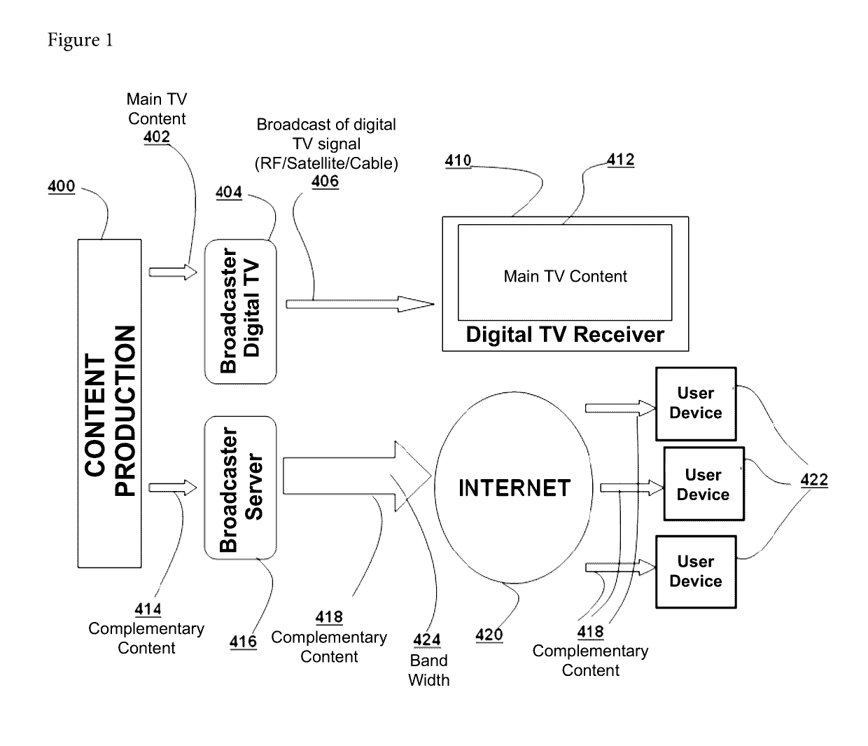

FIG. 1 illustrates this scenario, where the content producer (400) sends the main TV content (402) to the digital TV broadcaster (404), generating and transmitting the digital TV signal broadcast (410), being the main TV content reproduced in the screen and in the loudspeakers of the digital TV receiver (412). In parallel, the content producer (400) delivers the complementary content, normally audiovisual content and/or data (414) to the server (416) of the digital TV broadcaster connected to the Internet (420). The user devices (422) retrieve the complementary content (418) from the server (416) of the digital TV broadcaster and exhibit it in their respective screens. The requirements of band width (424) and computational capacity (416) of the digital TV broadcaster′ server increase according to the number of user devices (422) requesting the complementary content (418). Thus, using the Internet to deliver this type of content, the following drawbacks are inevitable:

a. the investment in broadband and server infrastructure, beside the station, increases proportionally to the number of users accessing the complementary contents.

b. the delivery reliability and user experience can be affected due to the band width and the quality of internet access on the user's side.

In addition, the carouseling techniques used in the data-broadcasting of the system described above, also known as interactive TV, have a limitation related to the maximum size of content sent in a carousel, not being possible to deliver large files such as video contents or, neither, live video content using the DSMCC-Data-Carousel or DSMCC-Object-Carousel protocols (ISO 13818-6).

The present invention allows the delivery of complementary content using the band width not used in the digital TV signal broadcast, avoiding the drawbacks of content delivery using the Internet as described above, without additional cost, with reliable delivery and guaranteed user experience independent on the availability of Internet access on the user's side.

### Technical Solution—Overview

The present invention allows the delivery of complementary contents, such as audio or video streams, without the limitation of the duration or size, including live audio or video streams.

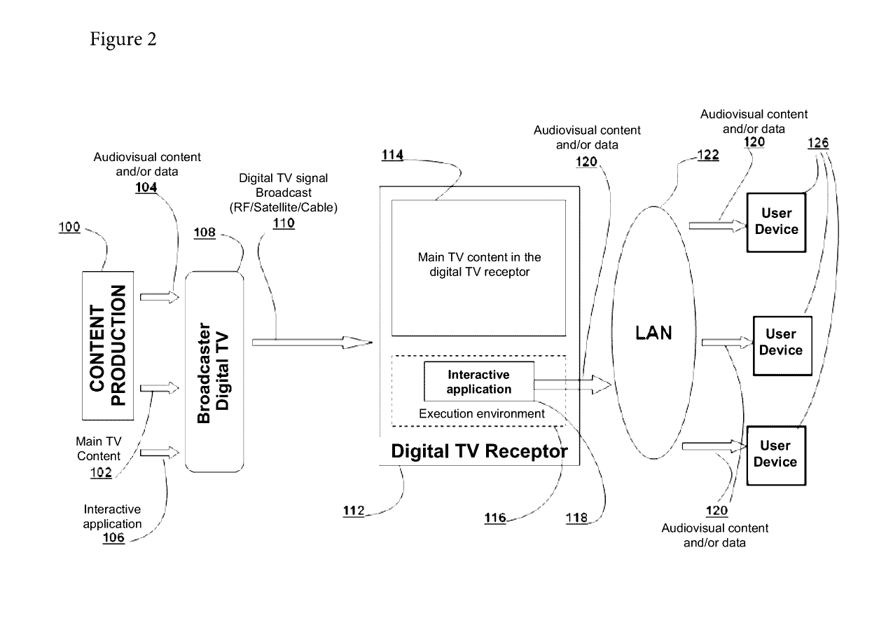

FIG. 2 shows an overview of the present invention. The process of content production (100) provides the main TV content (102), including audio, video, subtitles and/or closed caption, and any other content normally generated by a conventional digital TV broadcast service. In addition, the content production (100) provides the complementary contents, also referred as audiovisual content, intended to be played in the user devices (104). An interactive application (106) able to extract the audiovisual content and/or data (104) of the digital TV signal broadcast (110) coded as a MPEG2-transport-stream and forward such content and/or data to the user devices, is also provided. The digital TV broadcaster (108) generates and transmits a digital TV signal broadcast, including the main TV content (102), the audiovisual content and/or data (104) and the interactive application (106).

The digital TV receiver (112) tunes the digital TV signal broadcast, decoding the MPEG2-transport-stream and reproducing the main TV content, that is, audio, video, closed-captions/subtitles, etc., in the screen and in the loudspeakers, or alternatively, in the case of set-top-boxes, the contents are output through the respective audio and video outputs.

The digital TV receiver also decodes and executes the interactive application (118) within its execution environment (116). Examples of execution environment can be an interactive digital TV middleware, such as MHP, Ginga, etc. The interactive application (118) uses the API available in the execution environment (116) to extract from the MPEG2-transport-stream the MPEG2-private-sections containing the encapsulated audiovisual content and/or data (120). As examples of these API, it can be mentioned the API org.davic.mpeg.sections available in the systems based on the Globally Executable MHP specification (GEM) and the com.sun.dtv.filtering API specified by the Brazilian norm ABNT NBR 15606-6.

It is required that the digital TV receiver (112) to be connected to a LAN (122), which can be wired (for example, Ethernet), wireless (such as IEEE 802.11a/b/g/n networks or similar) or the combination of both types, wired and wireless.

Also, in order to the user devices (126) being able to receive and reproduce the audiovisual content and/or the data, it is required that they are connected in the same LAN (122) as the digital TV receiver (112). As an example, the user devices (126) can be any one of the types of tablets, smart-phones, personal computers or any other device able to be connected to the LAN (122) and having a screen and/or audio output, such as loudspeakers or headphones. In some implementations, the user devices (126) can host and execute one or more applications in order to implement the behaviors, functionalities and protocols which are attributed to them by the present invention.

### Technical Solution—Broadcaster's Side

The input of the process of the present invention is the content generated by the state of the art content production (200) workflow. The content production (200) provides the main TV contents (202), including audio, video, subtitles, closed-caption, and any other content usually generated generally for a conventional digital TV broadcast service. In addition, the content production (200) provides the complementary content, also referred as audiovisual contents, intended to be played in the user devices (204).

In case of the audiovisual content intended to be played in the user devices (204), as provided by content production (200), requires adaptations to be reproduced in the user devices or to be transmitted split in small chunks, a transcoder device (206) is used to re-encode the audiovisual content. Such adaptations can include, for example, the adjust of the video resolution and its aspect ratio, the audio and video bitrate, the audio and video encodings and any other adjust which can be necessary to convert the audiovisual content to a format possible to be sent as a stream. As an example of formats that can be sent as a stream it can be mentioned any of those used in the MPEG2-transport-stream protocols, RTP/RTPS, HLS, etc. The transcoder device (206) outputs an audiovisual content adapted to be played in the user devices (208). This step can be ignored in the case that the audiovisual content provided by content production (100) (200) is already in a format suitable to be played in the user devices (208) and to be transmitted in a stream form.

The audiovisual content already adapted to be played in the user devices (208) is then encapsulated in MPEG2-private-sections by a MPEG2-private-section encapsulator device (212). The MPEG2-private-section encapsulator device (212) generates a sequence of MPEG2-private-sections using a method consisting of following steps:

a. assign to the field table_id a predefined value;

b. assign to the field section_number a sequentially incremented value;

c. whenever the value of the field section_number reaches a preset value (in the range between 0 and 255) assigned to the field last_section_number, the sequence section_number is restarted in 0;

d. assign to the field version_number a value which is sequentially incremented whenever the sequence of the field section_number is restarted;

e. whenever the value of the field version_number reaches a maximum preset value for this field (in the interval between 1 and 31), the sequence is restarted for a preset initial value (in the range between 0 and the maximum preset value for version_number minus 1);

f. add to the field private_data_byte of the MPEG2-private-section, in an orderly manner, as many chunks or packages of the audiovisual content (208) as will fit within this field, without exceeding the maximum preset size defined for the MPEG2-private-section (usually, the maximum preset size is 4095 bytes);

g. calculate and set the values to the fields section_length and CRC;

h. divide the MPEG2-private-section in a sequence of MPEG2-transport-stream-packets (214) and set to all of them the same preset value to the field packet_id (PID); and

i. deliver the generated MPEG2-transport-stream-packets (214) to a MPEG2-transport-stream multiplexer (222).

The steps of (a) up to (i) are continuously repeated while there are audiovisual content available.

A variation of the step (f) of the method above allows the chunks or packages of audiovisual content to be divided between the current and next MPEG2-private-section to be generated, allowing, whenever applicable, the MPEG2-private-section to have the maximum size allowed (field section_length—normally 4095 bytes). This approach is more efficient as it allows to deliver more audiovisual content chunks and packages in less MPEG2-private-sections.

In some implementations according to the present invention, the transcoder device can provide an audiovisual content adapted for exhibition in the user devices in the format of a stream containing RTP control packages, RTP and RTP Session Descriptors packages, which are then encapsulated in MPEG2-private-sections by the MPEG2-private-section encapsulator device.

In other implementations according to the present invention, the transcoder device may provide an audiovisual content adapted to the exhibition in the user devices in the format of a stream containing MPEG2-transport-stream packages, which are then encapsulated in MPEG2-private-sections by the MPEG2-private-section encapsulator device.

In addition to the audiovisual content adapted to exhibition in user devices (208), the MPEG2-private-section encapsulator device (212) may generate MPEG2-private-sections containing chunks or structures of generic data which may be interpreted by the user devices (210). The encapsulation process is exactly the same as described for the audiovisual content adapted for exhibition in the user devices (208).

In addition, an interactive application (216), intended to be executed in the digital TV receiver, is coded by an interactive application encoder device (218).

The main TV content TV (202), the encoded interactive application (220) and the audiovisual content and/or data encapsulated in MPEG2-private-sections (214) are forwarded to the MPEG2-transport-stream multiplexer (222), that will generate a suitable MPEG2-transport-stream-signal (224) to be transmitted in a digital TV signal broadcast (226). Lastly, the digital TV transmitting device (226) transmits the digital TV signal broadcast. An example of these transmissions signals, it can be mentioned a terrestrial TV radio frequency signal, a satellite TV signal or a cable TV signal.

### Technical Solution—Reception Side

The digital TV receiver (112) tunes into the digital TV signal broadcast, decodes the MPEG2-transport-stream and reproduces the main TV content, that is, audio, video, closed-caption/subtitles, etc., in its screen and loudspeakers (114). Alternatively, in the case of set-top-boxes, the image and the sound are output through the respective audio and video outputs.

The digital TV receiver also decodes and executes the interactive application (118) within its execution environment (116). The execution environment can be an interactive digital TV middleware, such as MHP, Ginga, etc. The interactive application (118) uses the API available in the execution environment (116) to extract from MPEG2-transport-stream the MPEG2-private-sections containing the audiovisual content and/or encapsulated data (120). As examples of these API, it can be mentioned the API org.davic.mpeg.sections available in the systems based on Globally Executable MHP specification (GEM) or the API com.sun.dtv.filtering specified in the ABNT NBR 15606-6.

It is necessary that the digital TV receiver (112) to be connected to a LAN (122). This LAN (122) can be wired (as, for example, Ethernet), wireless (such as IEEE 802.11a/b/g/n networks or similar) or the combination of both types, wired and wireless.

Also, the user devices (126) must be connected in the same LAN (122) the digital TV receiver (112) in order to receive and reproduce the audiovisual content and/or the data. As an example, the user devices (126) can be any one of the types of tablets, smart-phones, personal computers or any other device able to be connected to LAN (122) and having a screen and/or audio output, such as loudspeakers or headphones. In some implementations, the user devices (126) can host and execute one or more applications in order to implement the behaviors, functionalities and communication protocols attributed to them by the present invention.

The interactive application (118), which is being executed in the digital TV receiver (112), and the user devices (126) communicate with each other using a common communication protocol for data networks. Such communication protocol for data networks is implemented by all user devices and the interactive application. The communication protocol for data networks includes the mechanism for discovery of interactive application and user devices, audiovisual content announcement, data announcement, audiovisual content request, data request, audiovisual content delivery and data delivery.

Using the communication protocol for data networks, the user devices (126):

a. become aware of the presence of interactive application;

b. become aware of the availability of the audiovisual content;

c. become aware of the availability of data;

d. request to the interactive application (118) the delivery of audiovisual content;

e. request to the interactive application (118) the delivery of data;

f. receive, from the interactive application (118), the audiovisual content (124);

g. receive, from the interactive application (118), the data (124).

The user devices (126) decode, process and reproduce in their respective screens and/or loudspeakers, the received audiovisual content and/or data.

### Technical Solution—Communication Protocol for Data Networks Between the Interactive Application and User Devices

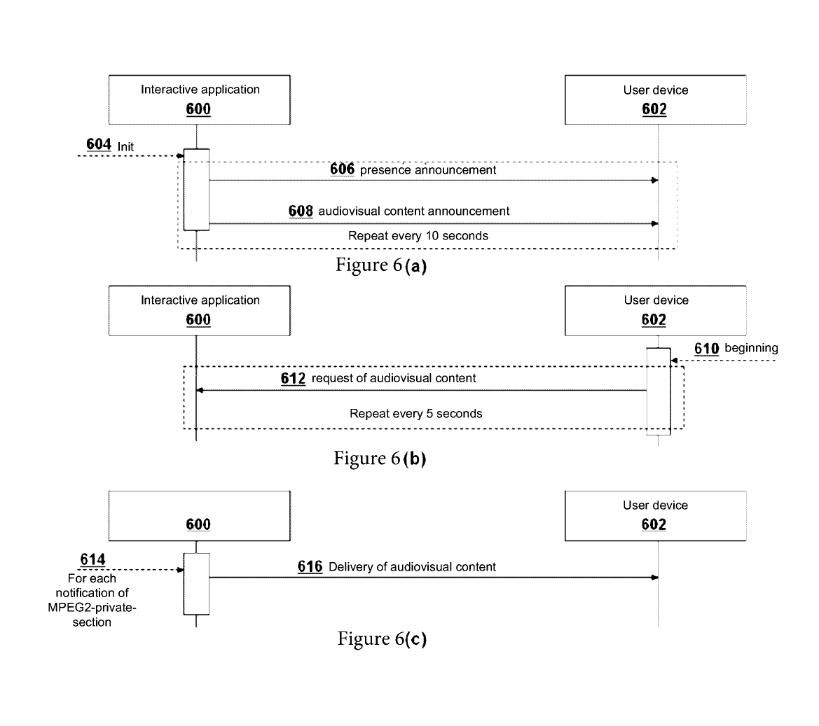

The interactive application (118) that is executed in the digital TV receiver (112) and the user devices (126) must implement a communication protocol for data networks which will allow the communication between them. It is necessary that all user devices (126) and the digital TV receiver (112) wherein the interactive application (118) is performed are connected to the same LAN (122). The communication protocol for data networks may contemplate, among others, the following mechanisms, such as illustrated in FIG. 6:

a. discovery (504): mechanism to allow the interactive application (500) and the user devices (502) to become aware of the presence of each other when connected to the same LAN;

b. audiovisual content announcement (506): mechanism that allows the user devices (502) to become aware of the availability of audiovisual content, provided through the interactive application (500) and intended to be consumed by user devices;

c. data announcement (508): mechanism that allows the user devices (502) to become aware of the availability of data, provided through the interactive application (500) and intended to be consumed by user devices;

d. request of audiovisual content (510): mechanism that allows the user devices (502) to request the interactive application (500) to deliver audiovisual content;

e. request of data (512): mechanism that allows the user devices (502) to request the interactive application (500) to deliver data;

f. delivery of audiovisual content (514): mechanism to deliver the audiovisual content from the interactive application (500) to the user devices (502);

g. delivery of data (516): mechanism to deliver data from the interactive application (500) to the user devices (502).

The communication protocol for data networks may be implemented as message exchanges using any combination of UDP datagrams (point-to-point UDP datagrams, point-to-multipoint UDP datagrams and broadcast UDP datagrams) and TCP connections.

In different implementations according to the present invention, the communication protocol may be designed to be started by interactive application (500), by the user devices (502), or any one of them.

The implementation of mechanisms to deliver audiovisual content and/or data can consider the delivery of raw MPEG2-private-sections as extracted from MPEG2-transport-stream. Alternatively, the implementation of mechanisms to deliver audiovisual content and/or data can consider the interactive application (500) which is being executed in the digital TV receiver to decode/process the MPEG2-private-sections extracted from MPEG2-transport-stream and deliver only the encapsulated audiovisual content and/or data to the user devices (502), discarding the header and the CRC of MPEG2-private-section.

In the case of user devices, the implementation of described communication protocol for data networks can be built-in in the user devices or implemented by one or more user applications installed and executed in the user devices.

### Technical Solution—General Advantages

The method used to define the values of the fields section_number and version_number allows the continuous delivery of new chunks or packages of audiovisual content (208) and/or data (210). The expiration time of such chunks and packages, encapsulated in MPEG2-private-sections (214), is generally very short and it is expected to be processed and discarded immediately by the user devices (126). If no user device (126) is available or does not have requested the delivery of audiovisual content, the interactive application (118) discards such chunk or package immediately. For this reason, the method according to the present invention can also be applied to live audiovisual content broadcasts.

### Examples

Hereinafter, it is demonstrated an example of implementation of methods, devices, protocols and interactive application of the present invention as detailed above. However, such example should not be considered limitative of the scope and the range of the present invention, since other forms of implementation could be envisioned by those skilled in the art.

### Example of Implementation—Broadcasting Side

### Example 1—Encoding of Audiovisual Content Using RTP Streams

The broadcasting system can be built upon the Brazilian digital TV system ISDB-T and easily integrated to the transmission workflow of a station.

The main TV contents can be the video and audio streams using encodings H.264 and MPEG-4 AAC respectively; closed-captions can also be included. Data for Electronic Programming Guide (EPG) and other service information (SI) metadata can be generated and included according to the standard ABNT NBR 15603.

The interactive application can be developed in accordance with the Ginga middleware standard (ABNT NBR 15606). It can use the API com.sun.dtv.filtering as specified in ABNT NBR 15606-6 to extract the MPEG2-private-sections from MPEG2-transport-stream comprised in the digital TV signal broadcast. The communication protocol for data networks can be implemented with the API provided by java.net package specified in the Personal Basis Profile 1.2.1, which is also included in the Ginga middleware standard (ABNT NBR 15606-4).

The interactive application encoder device may be implemented with a Ginga interactivity playout device used to encode the Ginga applications in the DSMCC Object Carousel protocol.

Multiplexing and broadcasting of the MPEG2-transport-stream can be done using the same equipment already used in the conventional ISDB-T digital TV broadcasts.

The audiovisual content for user devices provided by the content production process can be a FullHD video and audio stream, it can be prerecorded or live and they can be encoded using the encodings H.264 and MPEG-4 AAC, for video and audio respectively. The bitrate can have any value that allows a high quality broadcast to the FullHD format (for example: 13 Mbps).

The transcoder device re-encodes the FullHD video to a resolution, encoding, bitrate and frame rate suitable to be reproduced by user devices (for example, 720×362, H.264, 15 fps). Similarly, the audio is re-encoded to a format, bitrate, sample rate and encoding appropriate to be played in the user devices (for example, MPEG-4 AAC HE). The total bitrate is reduced to 500 Kbps. The adapted streams are generated by the transcoder device using the RTP/RTSP protocol as an RTP stream, containing RTP packages and RTP control packages. The transcoder device also generates the data structure of type RTP Session Descriptor.

The MPEG2-private-sections encapsulator device receives the RTSP stream packages, the RTP control packages and the RTP Session Descriptor generated by transcoder device and generates the MPEG2-private-sections adding the RTP/RTSP packages in the field private_data_byte. The MPEG2-private-sections generated are forwarded to the MPEG2-transport-stream multiplexor as a sequence of MPEG2-transport-stream-packets and, finally, inserted in the digital TV signal broadcast.

### Example 2—Encoding of Audiovisual Content Using MPEG2-Transport-Stream Streams

In other implementation example, derived from Example 1, the transcoder device re-encodes the FullHD video to a resolution, codification, bitrate and frame rate suitable to be played by user devices (for example, 720×362, H.264, 15 fps). Similarly, the audio is re-encoded to a format, bitrate, sample rate and encoding appropriate to be played in the user devices (for example, MPEG-4 AAC HE). The total bitrate is reduced to 500 Kbps. The adapted streams are generated by transcoder device using the MPEG2-transport-stream protocol as a stream, containing a sequence of MPEG2-transport-stream-packets, including the PSI required to decode the stream.

The MPEG2-private-sections encapsulator device receives the stream of sequence of MPEG2-transport-stream-packets generated by transcoder device and generates MPEG2-private-sections adding the MPEG2-transport-stream-packets in the field private_data_byte. The generated MPEG2-private-sections are forwarded to the MPEG2-transport-stream multiplexer as a sequence of MPEG2-transport-stream-packets and, finally, inserted in the digital TV signal broadcast.

### Example of Implementation—Reception Side

As an example of implementation of digital TV receiver, it can be considered either a TV apparatus or a set-top-box able to tune and decode the IDSB-T digital TV services, which also includes the Ginga interactive middleware support, according to ABNT NBR 15606 and able to be connected to a LAN through an Ethernet interface or Wi-Fi.

It should be emphasized that there are many user devices that can be used, such as any user smart-phone or tablet in which it is installed and executing an application implementing the same communication protocol for data networks implemented by Ginga interactive application being broadcasted in the ISDB-T digital TV signal broadcast as described in the previous section. This application can have a user interface that allows the user to select and reproduce the audiovisual content which is being delivered encapsulated in MPEG2-private-sections. Normally, this functionality could be part of a much more complex application such as a second-screen application.

### Example of Implementation—Communication Protocol for Data Networks Between the Interactive Application and the User Devices

The interactive application can be developed in accordance with the Ginga middleware specification, the ABNT NBR 15606 standard. The communication protocol for data networks can be implemented with the API available in java.net package, specified in the Personal Basis Profile 1.2.1, which is also part of the Ginga middleware specification, as the Brazilian ABNT NBR 15606-4 standard.

In case of the application that is executed in the user devices, the communication protocol for data networks can be implemented using the network access API available in such platforms (for example, iOS and Android).

In this example, the discovery mechanism may be implemented, as illustrated in FIG. 6.a, by the interactive application (600) sending a message as a broadcast UDP datagram each 10 seconds.

In this example, the audiovisual content and data announcement mechanisms can be implemented, as shown in FIG. 6.a, so that interactive application (600) sends a message, containing information and details about the audiovisual content and available data, as a broadcast UDP datagram each 10 seconds.

The audiovisual content request mechanism and data request mechanism can be implemented, as shown in FIG. 6.b, such as the application executed in the user devices (602) sends a message requesting the delivery of the announced audiovisual content and/or data (612) to the interactive app (600), as a point-to-point UDP datagram. Each user device must send this message (612) on each 5 seconds. If the interactive application (600) stops receiving this message (612) from a given user device (602) for a certain time (ex: 10 sec), the interactive application (600) assumes that the user device (602) is no longer interested in receiving the audiovisual content and/or data and will stop the delivery to this given user device (602).

The audiovisual content delivery mechanism and the data delivery mechanism can be implemented, as shown in FIG. 6.c, so that the interactive application (600) sends messages (616) containing audiovisual content and/or data to each user device (602) that have previously requested such delivery. These messages (616) can be sent through the LAN as point-to-point UDP datagrams. The messages (616) can be sent one for each MPEG2-private-section (614) extracted from MPEG2-transport-stream by API com.sun.dtv.filtering, and it may carry all the contents of such MPEG2-private-section.

In other example of implementation of this solution, the audiovisual content request mechanism and data request mechanism can be implemented is such a way that the application executed in the user devices establishes a TCP connection with the interactive application. Once established this TCP connection, the audiovisual content and/or data delivery will occur by the time the TCP connection is open. In this case, the interactive application will send, through this TCP connection, messages containing the audiovisual content and/or data. The messages can be sent one for each MPEG2-private-section extracted from MPEG2-transport-stream by API com.sun.dtv.filtering, it may carry all the contents of such MPEG2-private-section. The TCP connection may be closed by the user devices, indicating to the interactive application that it must interrupt the delivery of audiovisual content and/or data.

1. A method for encapsulating audiovisual content streams in MPEG2 private sections, generated in an orderly manner, consisting of the following steps:
a. attribute to the field table_id a preset value;
b. attribute to the field section_number a sequentially incremented value;
c. whenever the value of the field section_number reaches a preset value (in the range between 0 and 255) attributed to the field last_section_number, the section_number sequence is restarted to 0;
d. attribute to the field version_number a value that is sequentially incremented whenever the sequence of the field section_number is restarted;
e. whenever the value of the field version_number reaches a maximum preset value for this field (in interval between 1 and 31), the sequence is restarted for an initial preset value (in the range between 0 and the maximum preset value for version_number minus 1);
f. add, in an orderly manner, to the field private_data_byte of the MPEG2 private section as many chunks or packages of the audiovisual content as it would fit within this field, without exceed the maximum preset size for the MPEG2 private section;
g. calculate and attribute the values for the fields section_length and CRC;
h. divide the MPEG2 private section in a sequence of MPEG2 transport stream packets and attribute to all of them the same preset value to the field packet_id (PID).

2. The method as claimed 1, wherein the audiovisual content streams includes RTP control packages, RTP packages, RTSP packages or combinations thereof.

3. The method as claimed 2, wherein some MPEG2 private section contains RTP Session Descriptors.

4. The method as claimed 1, wherein audiovisual content streams are included in a stream of packages of an MPEG2 transport stream.

5. A device to encapsulate audiovisual content in MPEG2 private sections to be multiplexed in a MPEG2 transport stream comprising an input for receiving an audiovisual content stream; an output for outputing a generated sequence of MPEG2-private-sections; and an electronic circuit including a processor and RAM memory and the set of encoded instructions to execute, in a loop, the following steps:
a. attribute to the field table_id a preset value;
b. attribute to the field section_number a sequentially incremented value;
c. whenever the value of the field section_number reaches a preset value (in the range between 0 and 255) attributed to the field last_section_number, the section_number sequence is restarted to 0;
d. attribute to the field version_number a value that is sequentially incremented whenever the sequence of the field section_number is restarted;
e. whenever the value of the field version_number reaches a maximum preset value for this field (in interval between 1 and 31), the sequence is restarted for an initial preset value (in the range between 0 and the maximum preset value for version_number minus 1);
f. add, in an orderly manner, to the field private_data_byte of the MPEG2 private section as many chunks or packages of the audiovisual content as it would fit within this field, without exceed the maximum preset size for the MPEG2 private section;
g. calculate and attribute the values for the fields section_length and CRC;
h. divide the MPEG2 private section in a sequence of MPEG2 transport stream packets and attribute to all of them the same preset value to the field packet_id (PID).

6. The device to encapsulate the audiovisual content in MPEG2 private sections to be multiplexed in a MPEG2 transport stream according to claim 5, wherein the audiovisual content streams includes RTP control packages, RTP packages, RTSP packages or combinations thereof.

7. The device to encapsulate the audiovisual content in MPEG2 private sections to be multiplexed in a MPEG2 transport stream according to claim 6, wherein some MPEG2 private section contains RTP Session Descriptors.

8. The device to encapsulate the audiovisual content in MPEG2 private sections to be multiplexed in a MPEG2 transport stream according to claim 5, wherein audiovisual content streams are included in a stream of packages of an MPEG2 transport stream.

9. An interactive application for digital TV, transmitted in a digital TV signal broadcast and executed in a digital TV receiver, comprising executable code compatible with the interactivity standards for digital TV, and that said code:
a. implements a communication protocol for local area networks based on IP, where in such communication protocol offers the following mechanisms for communication between the interactive application and the user devices that are connected to the local area network:
i. discovery: mechanism to allow the interactive application and the user devices to become aware of the presence of each other when connected to the same local area networks;
ii. audiovisual content announcement: mechanism that allows the user devices to become aware of availability of audiovisual content, provided through the interactive application and intended to be consumed by the user devices;
iii. data announcement: mechanism that allows the user devices to become aware of availability of data, provided through the interactive application and intended to be consumed by the user devices;
iv. request of audiovisual content: mechanism that allows the user devices to request the interactive application to deliver audiovisual content;
v. request of data: mechanism that allows the user devices to request the interactive application to deliver data;
vi. delivery of audiovisual content: mechanism to delivery audiovisual content from the interactive application to the user devices;
vii. delivery of data: mechanism to deliver data from the interactive application to the user devices;
b. uses the mechanisms available in digital TV receiver to extract MPEG2 private sections from the MPEG2 transport stream of the digital TV signal broadcast; and
c. uses the communication protocol for data networks according to a) to deliver to other user devices connected to the local area network, the contents (total or partial) from the MPEG2 private sections extracted from MPEG2 transport stream according to b).

10. A user device consisting of an electronic circuit including a processor and RAM memory; interfaces to wired or wireless connection to the local are network based in IP; and the set of encoded instructions that:
a. implements a communication protocol for local area networks based on IP, where in such communication protocol offers the following mechanisms for communication between the interactive application and the user devices that are connected to the local area network:
i. discovery: mechanism to allow the interactive application and the user devices to become aware of the presence of each other when connected to the same local area networks;
ii. audiovisual content announcement: mechanism that allows the user devices to become aware of availability of audiovisual content, provided through the interactive application and intended to be consumed by the user devices;
iii. data announcement: mechanism that allows the user devices to become aware of availability of data, provided through the interactive application and intended to be consumed by the user devices;
iv. request of audiovisual content: mechanism that allows the user devices to request the interactive application to deliver audiovisual content;
v. request of data: mechanism that allows the user devices to request the interactive application to deliver data;
vi. delivery of audiovisual content: mechanism to delivery audiovisual content from the interactive application to the user devices;
vii. delivery of data: mechanism to deliver data from the interactive application to the user devices;
b. allows to receive, decode, process and play audiovisual content delivered from an interactive application executed in the digital TV receiver connected to the same local area network.

11. A method for delivering of audiovisual content and/or data to user devices without capabilities to tune a digital TV signal broadcast through a digital TV signal broadcast comprising the following steps:
a. encapsulating audiovisual content streams in MPEG2 private sections following the steps below:
i. attribute to the field table_id a preset value;
ii. attribute to the field section_number a sequentially incremented value;
iii. whenever the value of the field section_number reaches a preset value (in the range between 0 and 255) attributed to the field last_section_number, the section_number sequence is restarted to 0;
iv. attribute to the field version_number a value that is sequentially incremented whenever the sequence of the field section_number is restarted;
v. whenever the value of the field version_number reaches a maximum preset value for this field (in interval between 1 and 31), the sequence is restarted for an initial preset value (in the range between 0 and the maximum preset value for version_number minus 1);
vi. add, in an orderly manner, to the field private_data_byte of the MPEG2 private section as many chunks or packages of the audiovisual content as it would fit within this field, without exceed the maximum preset size for the MPEG2 private section;
vii. calculate and attribute the values for the fields section_length and CRC;
viii. divide the MPEG2 private section in a sequence of MPEG2 transport stream packets [214] and attribute to all of them the same preset value to the field packet_id (PID).
b. multiplexing the MPEG2 private sections within a MPEG2 transport stream which forms a digital TV signal broadcast;
c. include in the digital TV signal broadcast an interactive application implementing, at least, the functionalities as claimed in 9;
d. tune the digital TV signal broadcast with a digital TV receiver;
e. decode the digital TV signal and reproduce the main TV content in a digital TV receiver;
f. executing, in the execution environment of the digital TV receiver, the interactive application received within the digital TV signal broadcast;
g. using a communication protocol for data networks implemented within the interactive application to discover other user devices connected to the local area network and announce the availability of audiovisual content and/or data;
h. the usage of the communication protocol for data networks implemented in the user devices or by applications installed in the user device, to request to the interactive application the delivery of audiovisual content and/or data;
i. the usage of the communication protocol for data networks implemented within the interactive application, to deliver the audiovisual content and/or data to the user devices that have requested such delivery;
j. receiving in the user devices, which have requested the delivery of audiovisual content and/or data to the interactive application, such audiovisual contents and/or data using the communication protocol for data networks implemented by the user devices or by applications installed in the user device;
k. decoding, processing and playing back the requested audiovisual contents and/or data in the user device.

12. The method as claimed in 11, wherein the TV signal broadcast can be terrestrial, satellite or wired.

13. One or more applications that are executed in a user device and consisting of executable code compatible with said user device, that:
a. implements a communication protocol for local area networks based on IP, where in such communication protocol offers the following mechanisms for communication between the interactive application and the user devices that are connected to the local area network:
i. discovery: mechanism to allow the interactive application and the user devices to become aware of the presence of each other when connected to the same local area networks;
ii. audiovisual content announcement: mechanism that allows the user devices to become aware of availability of audiovisual content, provided through the interactive application and intended to be consumed by the user devices;
iii. data announcement: mechanism that allows the user devices to become aware of availability of data, provided through the interactive application and intended to be consumed by the user devices;
iv. request of audiovisual content: mechanism that allows the user devices to request the interactive application to deliver audiovisual content;
v. request of data: mechanism that allows the user devices to request the interactive application to deliver data;
vi. delivery of audiovisual content: mechanism to delivery audiovisual content from the interactive application to the user devices;
vii. delivery of data: mechanism to deliver data from the interactive application to the user devices;
b. receives, decodes, processes and plays back the audiovisual content delivered from an interactive application executed in a digital TV receiver connected to the same local area network the user device is connected.

14. The communication protocol for data networks claimed in claim 9, wherein the mechanisms can be implemented as messages sent as point-to-point datagrams UDP, point-to-multipoint UDP datagrams, broadcast UDP datagrams, TCP connections or combinations of these technologies.

15. The communication protocol for data networks claimed in claim 10, wherein the mechanisms can be implemented as messages sent as point-to-point datagrams UDP, point-to-multipoint UDP datagrams, broadcast UDP datagrams, TCP connections or combinations of these technologies.

16. The communication protocol for data networks claimed in claim 11, wherein the mechanisms can be implemented as messages sent as point-to-point datagrams UDP, point-to-multipoint UDP datagrams, broadcast UDP datagrams, TCP connections or combinations of these technologies.

17. The communication protocol for data networks claimed in claim 13, wherein the mechanisms can be implemented as messages sent as point-to-point datagrams UDP, point-to-multipoint UDP datagrams, broadcast UDP datagrams, TCP connections or combinations of these technologies.
